(19) United States
(12) Patent Application Publication
(10) Pub. No.: US 2011/0198269 A1
(43) Pub. Date: Aug. 18, 2011

(54) Vibratory screen device

(76) Inventors: Grant Young, Tulsa, OK (US); Ray Young, Glenpool, OK (US)

(21) Appl. No.: 12/658,686

(22) Filed: Feb. 16, 2010

(51) Int. Cl. B07B 1/46; B07B 1/28

(52) U.S. Cl. 209/365.1

(57) ABSTRACT

A vibrating screen device has a screen assembly and a basket. The screen assembly comprises a plurality of screens disposed within the vibrating screen device. The plurality of screens are constructed and arranged in a stepped down configuration such that each screen that is arranged below an adjacent screen in a stepped down configuration is at least partially overlapped by the adjacent screen arranged above. Each screen has a middle portion and a perimeter portion. The middle portion is porous, and the perimeter portion is substantially thicker than the middle portion.

### CROSS-REFERENCE TO RELATED APPLICATIONS

Not Applicable

### STATEMENT REGARDING FEDERALLY SPONSORED RESEARCH

Not Applicable

### FIELD OF THE INVENTION

This invention relates to shakers for separating solids from a fluid.

### BACKGROUND OF THE INVENTION

Shakers or other vibrating screen devices can be used to separate solids from fluids. Some shakers have multiple screens with a screen/mesh for separating the solids from the fluid. The fluid passes through the screen/mesh and the solids remain atop the screen/mesh. Most of these screens have a frame perimeter where the fluid cannot pass through nor do the solids convey as quickly as on the screen/mesh. The screens can have a stepped arrangement. Solids fall from the discharge end of each screen to the feed end of the next screen. There is often a small gap between the basket step and the leading edge of the screen. Solids fall down on into this gap as well as on the frame of the screen. Solids in the gap as well as on the frame of the screen have a more difficult time being conveyed out of this area. Furthermore this solids slurry puts pressure on the screen which may result in solids bypassing the screen. Surface tension forces in the fluid make it very difficult for solids slurry's to convey on nonporous surfaces. Solids tend to collect in the step area until they form enough mass to convey out of this area. There is a need for a shaker or screening machine that diminishes or eliminates this build-up of solids on the screens.

The instant invention as disclosed within this application, provides a screen that fills this need. The art referred to and/or described within this application is not intended to constitute an admission that any patent, publication or other information referred to herein is “prior art” with respect to this invention. In addition, this section should not be construed to mean that a thorough search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well, only for the purposes of complying with 37 C.F.R. 1.72. The abstract is not intended to be used for interpreting the scope of the claims.

### BRIEF SUMMARY OF THE INVENTION

In at least one embodiment of the invention, the vibrating screen device has a basket and screen assembly comprising a plurality of screens, the screens within the vibrating screen device can be disposed over the basket. The plurality of screens can be constructed and arranged in a stepped down configuration such that each screen that is arranged below an adjacent screen in a stepped down configuration is at least partially overlapped by the adjacent screen arranged above. Each screen can have a middle portion and a perimeter portion wherein the middle portion can be porous and the perimeter portion can be substantially thicker than the middle portion.

In some embodiments, the middle portion can comprise a mesh material.

In some embodiments, the mesh material can be disposed on a framework joined to the perimeter portion.

In some embodiments, the middle portion can have a rigid sheet having perforations.

In some embodiments, the mesh material can be disposed on the rigid sheet having perforations.

In some embodiments, the rigid sheet is disposed on a framework joined to the perimeter portion.

In some embodiments, the vibrating screen device has at least one wedge block. In some embodiments, the wedge block forms a seal against the screen, in some embodiments primarily on the perimeter portion of the screen

In some embodiments, a wedge block can have a side skirt that can engage a second wedge block disposed below.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is a perspective view of a prior art shaker having multiple screens

FIG. 2a is a top view of a screen

FIG. 2b is a cross-sectional side view of a screen

FIG. 3a is a schematic side view of two adjacent screens.

FIG. 3b is a schematic side view of two adjacent screens which overlap.

FIG. 4 is a cut-away schematic perspective view of multiple screens within an inventive shaker.

FIG. 5a is a perspective view of a first side of an inventive wedge block.

FIG. 5b is a perspective view of a second side of an inventive wedge block.

FIG. 6 is a perspective view of multiple screens within an inventive shaker.

FIG. 7 is a perspective view of multiple screens within an inventive shaker.

FIG. 8 is a perspective view of an inventive shaker with the screens removed.

FIG. 9a-b are perspective views of a gear wrench.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated. In some embodiments, the basket can have its sides defined by the sides of the vibrating screen device disposed under one or a plurality of screens. The stepped down configuration can include different levels of screens wherein there is an uppermost level and a lowermost level. These steps can proceed in a straight line or in other configurations (e.g. spiraling down steps). Additionally, within this application the term “proximal” end of the shaker is the end in which the slurry is introduced; the “distal” end of the shaker is the end toward which the separated solids are conveyed. The “proximal” and “distal” terms can also be applied to the baskets, screens, and wedge blocks with the same orientation.

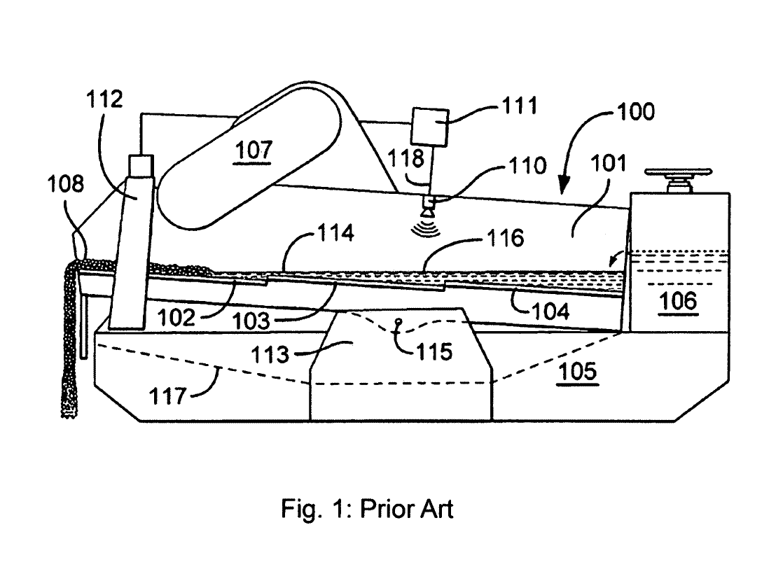

In FIG. 1 a Prior Art shaker is shown. The inventive screen configuration can be used in the prior art shaker. FIG. 1 shows a shale shaker 100 which has a basket 101 vibrated by interconnected vibrating apparatus 107. The basket 101 supports three screens 102, 103, 104 for treating material introduced onto screen 104 from a tank 106. Here, an ultrasonic level sensor 110 is connected to the basket 101 and selectively senses the distance to, and, therefore the level of the material 114 (e.g., drilling fluid with solids entrained therein) at a location 116 above the screen 103. A control apparatus 111 controls the sensor 110 via a cable 118 and also, via the cable 118, the sensor 110 sends signals to the control apparatus 111 indicative of a measurement of the level at the location 116. In one aspect the control apparatus 111 includes suitable apparatus (e.g. like the apparatus 70 described above) which calculates the depth at the location 116 and, based on suitable programming in suitable programming media in the control apparatus 111, adjusts the inclination of the basket 101 using adjustment apparatus 112 so that the depth at the location 116 is maintained at a desired level.

In one aspect the basket 101 is pivotally connected to a support 113 at a pivot point 115. The support 113 is secured to a base 105, as is the tank 106 and adjustment apparatus 112. Fluid and/or solid material flowing through the screens 102-104 flows down into a receptacle 117. Separated material 108 flows off an exit end of the last screen 102.

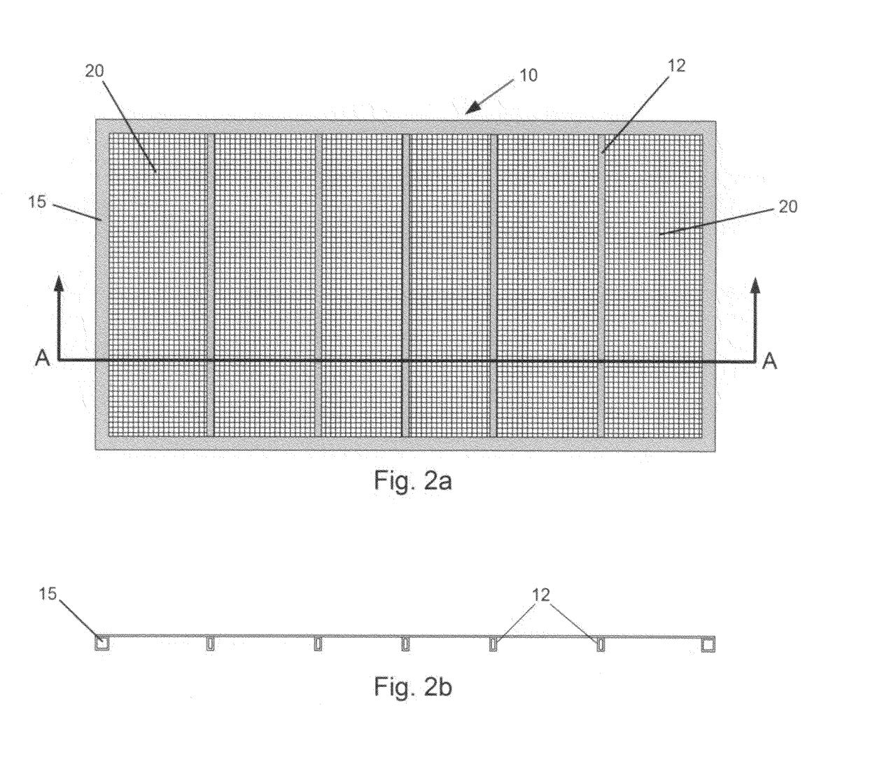

In FIGS. 2a and 2b a representative screen 10 is shown having a perimeter portion 15 and a middle portion 20 with a framework including support struts 12. The support struts can extend from the perimeter portion 15 and extend in a length-wise and/or width-wise direction. The length of the screen is the distance from the proximal most portion of the screen 10 to the distal most portion of the screen. The width of the screen is the distance across the screen that is perpendicular to the length. In some embodiments multiple struts 12 extending from the perimeter portion 15 can cross one or more struts extending from the perimeter portion in a different direction (e.g. a screen having struts extending length-wise and width-wise). The perimeter portion can be a frame with a thickness substantially greater than that of the middle portion. The perimeter portion 15 can provide structural strength for the screen 10. The middle portion 20 can be porous in that a fluid can pass through the middle portion. In some embodiments the middle portion is constructed of a porous material, the porous material can include naturally porous material or that which is manufactured (e.g. perforated plate, wedge wire material, a weave, a mesh, layers of mesh, any combination of these). In some embodiments the porous material of the middle portion 20 extends outwardly onto the perimeter portion 15. In some embodiments the porous material of the middle portion 20 is attached to the perimeter portion 15 without extending onto the perimeter portion 15. Though FIGS. 2a and 2b illustrate the use of struts 12, in some embodiments no struts are used and the perimeter portion 15 provides structural strength for the screen 10.

In some embodiments the middle portion 20 and the perimeter portion 15 are constructed of the same material. In some embodiments the perimeter portion provides structural strength while also being porous. In some embodiments, as shown in FIG. 2b, the perimeter portion is constructed of rectangular tubing. In some embodiments, the tubing has a square cross-section. In some embodiments, the tubing is 1″ square tubing. The tubing can be constructed of a rigid material such as steel. In some embodiments other metals and/or plastics are used. In some embodiments tubing supports are positioned within the outer steel frame.

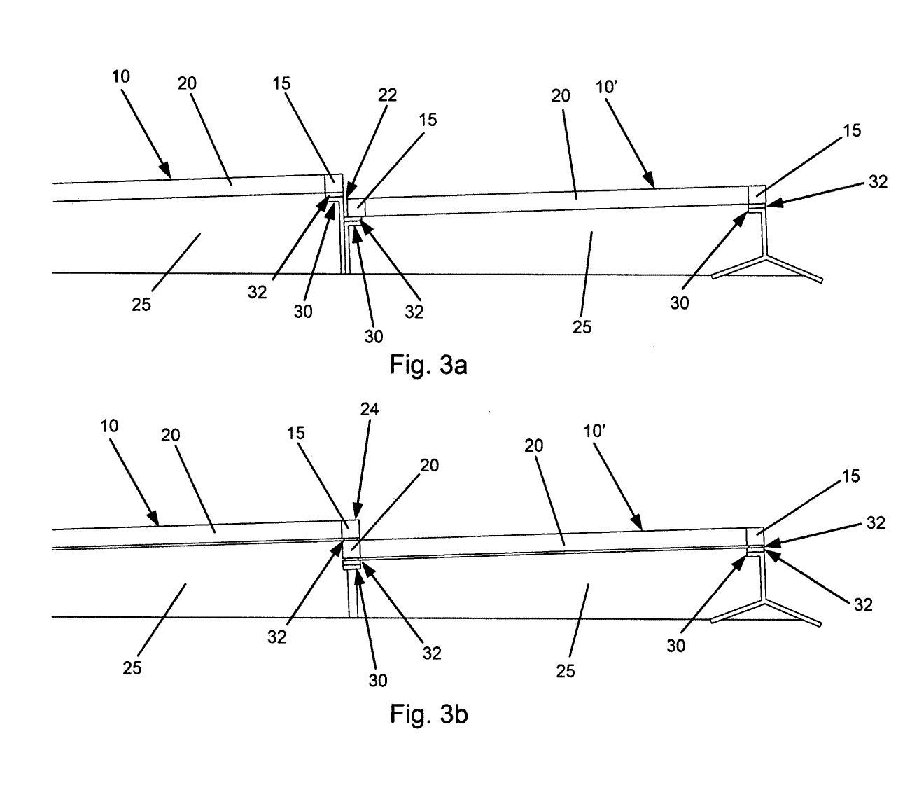

In FIG. 3a a schematic side view of two adjacent screens 10/10′ is shown. Here the screens 10 are arranged in a steeped down configuration. Each screen is disposed within a basket 25 on supports 30. There is a gap 22 shown. Solids can gather in the gap and do not convey from that area as easily as when on the middle portion 20 of the screen 10. Solids in the gap area can put pressure on the seals 32 located below the perimeter portion. Due to lack of porosity, solids located on the perimeter portion can also not convey as well as on the porous middle portion 15.

In FIG. 3b a schematic side view of two adjacent screens 10/10′ is shown with an overlapping portion 24. The overlapping portion 24 of the upper screen 10 extends over the perimeter portion 15 of lower screen 10′ and covers the gap 22 as shown in FIG. 3a. Conveyance of solids can be improved in this manner. The solids slurry can move from the upper screen 10 to the lower screen 10′ and be conveyed more easily on the porous middle portion 20 of lower screen 10′ without having to be conveyed over the perimeter portion 15′ of the proximal side of the screen 10′. In some embodiments the distal portion of the upper screen 10 forms a seal with the proximal portion of the lower screen 10′ perimeter.

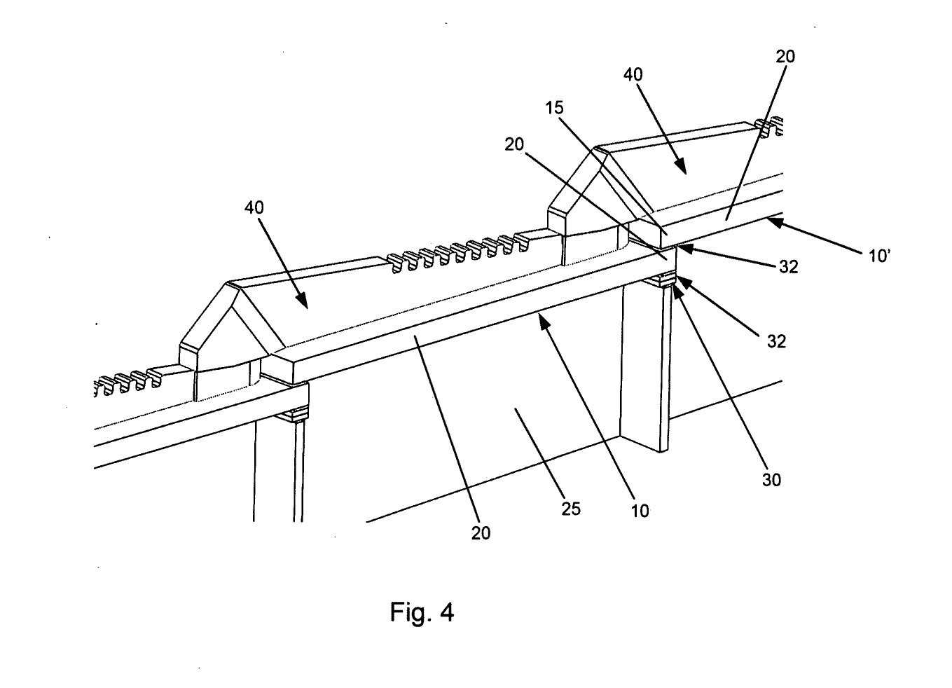

In FIG. 4 a stepped configuration having multiple screens 10 is shown. Here each screen 10 overlaps the screen disposed beneath it. Additionally, inventive wedge blocks 40 are used and can hold the sides of the screens in place. A seal can be formed between the wedge blocks 40 and the screen 10. In some embodiments one or more seal(s) 32 is formed specifically between the wedge blocks 40 and the perimeter portion 15 of the screen 10.

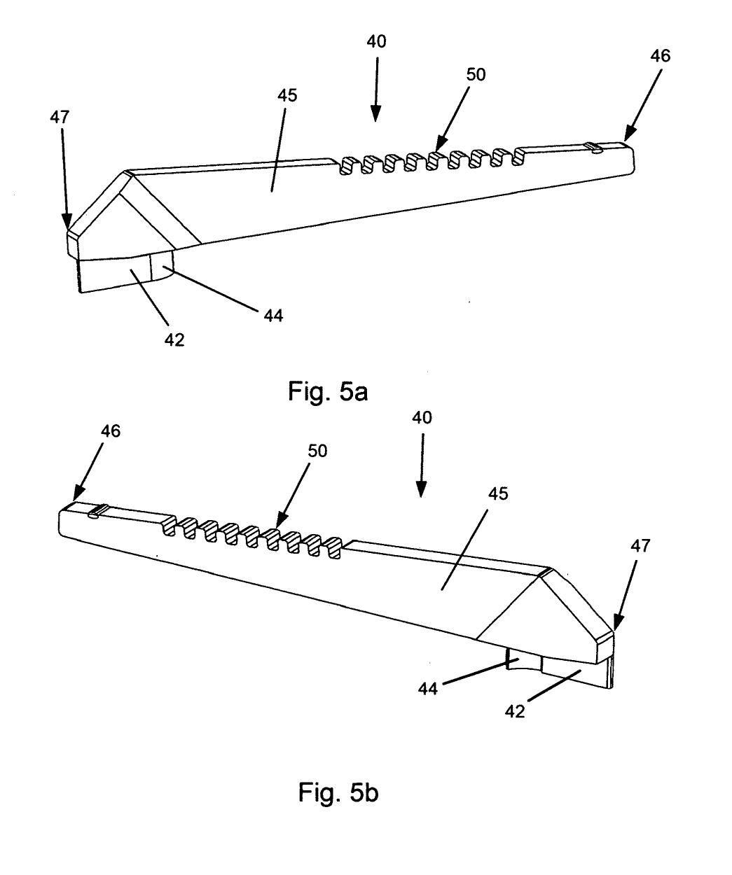

In FIGS. 5a and 5b an inventive wedge block 40 is shown. The wedge block 40 has a main body 45 and a side skirt 42 with a flexible side skirt seal 44. In some embodiments the wedge block main body 45 of one wedge block forms a seal with a screen 10 and the side skirt 42 and flexible side skirt seal 44 engage a different wedge block 40 that is disposed lower and distal. The side skirt 42 and/or flexible side skirt seal 44 can interlock and/or form a seal with the wedge block disposed lower and/or the edge of the screen 10. The wedge block 40 is narrower at the proximal end 46 than at the distal end 47 and has a toothed portion 50. The toothed portion can be used as teeth for engaging a gear for wedge block installation and removal.

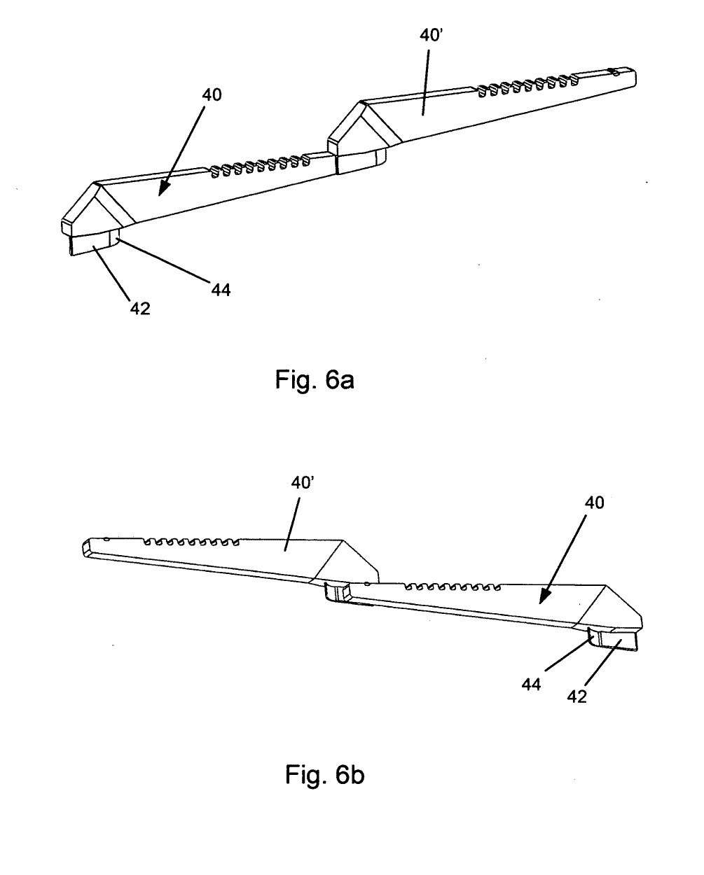

FIGS. 6a and 6b illustrate the wedge blocks 40/40′ when interlocked. As shown, the wedge blocks 40/40′ are positioned as when engaged within a shaker and disposed upon screens 10. As noted above the side skirt 42 and/or flexible side skirt seal 44 of the more proximal wedge block 40′ can interlock and/or form a seal with the more distal wedge block 40 disposed at a lower level. As shown in this interlocked position, the wedge blocks also can engage and/or seal against the screens 10 shown in FIG. 4.

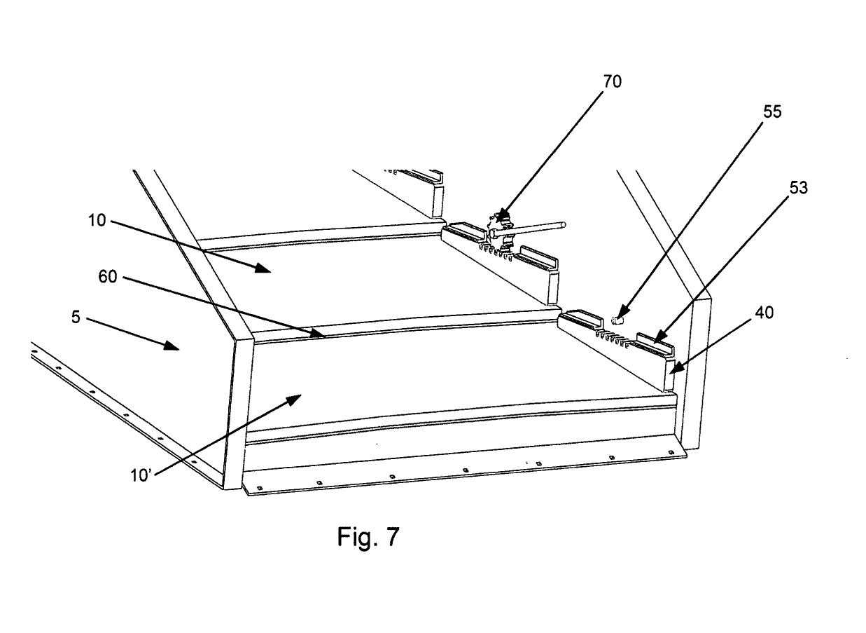

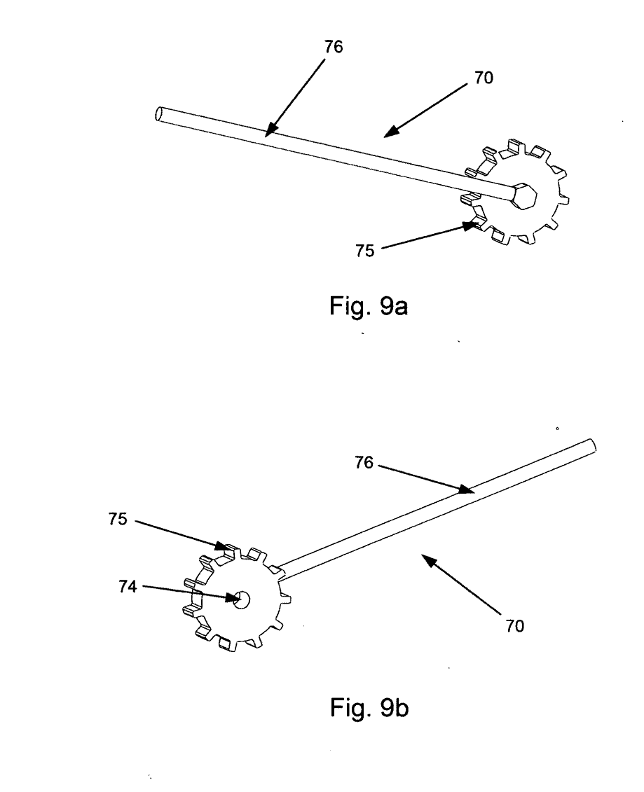

The wedge block 40 of FIGS. 5a/b and 6a/b can be used in the shaker 5 shown in FIG. 7. The wedge block 40 actually being shown here is different in that it does not have a side skirt. Nevertheless the wedge blocks 40 can be installed into the shaker 5 similarly. The shaker 5 includes side brackets 53 and side stub 55. The wedge block 40 is placed between the screen 10 and the brackets 53. A gear wrench 70 can be placed on the side stub 55 such that the gear wrench 70 is capable of rotating about the stub 55. As shown in FIGS. 9a-b, the gear wrench 70 includes a handle 76, an engagement hole 74, and teeth 75 disposed thereabout. The engagement hole 74 can engage the side stub 55 such that the gear wrench 70 can rotate about the side stub 55. The teeth 75 of the gear wrench 70 can engage the toothed portion 50 of the wedge block 40. Then by turning the gear wrench 70 the wedge block 40 can advance in a proximal direction such that a thicker portion of the wedge block is between the brackets 53 and the screen 10; this can create a seal between the wedge block 40 and the screen 10 and/or tighten the screen within the shaker/vibrating screen device. The gear wrench 70 could be replaced with a gear that was affixed to the shaker 5. The gear could then be rotated electronically, pneumatically, or with a combustion motor.

The wedge blocks 40 shown in FIG. 7 do not engage another wedge block 40. Rather, in some embodiments the proximal most end of the wedge block 40 abuts a portion of the basket support 25 and/or seal 30 and/or the distal end of the upper screen 10 disposed above the lower screen 10′ to form a seal. In some embodiments, the distal end of a wedge block 40 can overlap the proximal end of a wedge block disposed below; in some embodiments a seal is formed between the wedge blocks 40.

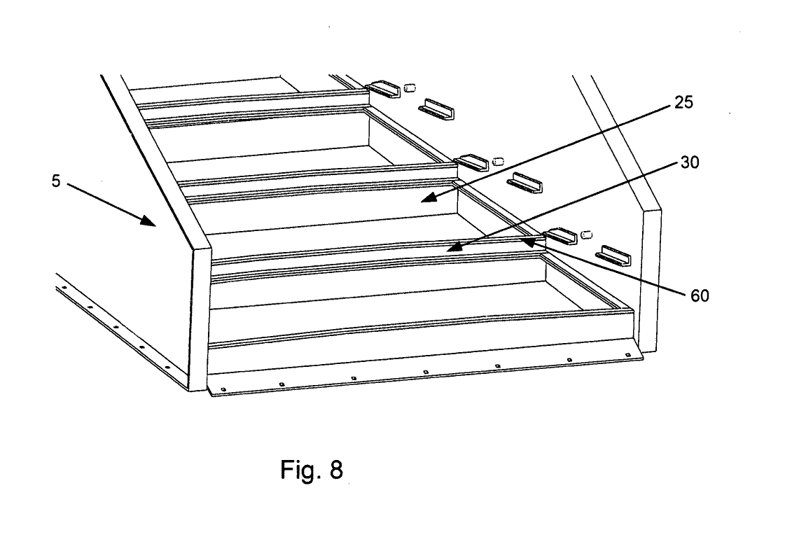

A shaker 5 without the screens 10 is shown in FIG. 8. The shaker has multiple baskets 25 over which screens 10 can be placed. The baskets 25 have basket supports 30 which provide seats for the screens 10 in the shaker 5. A seal 60 is placed about the supports 30 in order to provide a fluid tight seal between the basket support 30 and the screen 10. In some embodiments the seal 60 is placed on the perimeter portion 15 of the screen 10 rather than the basket support 30. In some embodiments the seal material 60 is placed on both the basket support 30 and the perimeter portion 15 of the screen 10. In some embodiments the seal is an elastomeric gasket or a flexible coating.

For the purposes of this disclosure, like reference numerals in the figures shall refer to like features unless otherwise indicated.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A screen assembly in a vibrating screen device, the vibrating screen device having a basket the screen assembly comprising a plurality of screens, the screens disposed within the vibrating screen device, the plurality of screens constructed and arranged in a stepped down configuration, each screen that is arranged below an adjacent screen in a stepped down configuration is at least partially overlapped by the adjacent screen arranged above, each screen having a middle portion and a perimeter portion, the middle portion being porous, the perimeter portion being substantially thicker than the middle portion.

2. The screen assembly of claim 1 wherein the middle portion comprises a mesh material.

3. The screen assembly of claim 2 wherein the mesh material is disposed on a framework, the framework being joined to the perimeter portion.

4. The screen assembly of claim 1 wherein the middle portion comprises a rigid sheet having perforations.

5. The screen assembly of claim 4 wherein the mesh material is disposed on the rigid sheet.

6. The screen assembly of claim 5 wherein the rigid sheet is disposed on a framework, the framework being joined to the perimeter portion,

7. The screen assembly of claim 1 wherein the screens are held in place in a vibrating basket, such that the screens move with the basket.

8. The screen assembly of claim 1 further comprising at least one wedge block.

9. The screen assembly of claim 8 wherein the at least one wedge block forms a seal against the screen.

10. The screen assembly of claim 8 wherein the at least one wedge block has a narrow end and a wide end with a top edge and bottom edge extending between the narrow end and the wide end, in an engaged state the bottom edge engages the screen forming a seal with the screen and the top edge engages a brace secured to the vibrating screen device, in an unengaged state the bottom edge does not form a seal with the screen.

11. The screen assembly of claim 10 wherein the top edge has a toothed portion, the toothed portion constructed and arranged to engage a gear, the gear having a stationary tightened state wherein the at least one wedge is in the engaged state and having a moving state wherein the gear is moving the at least one wedge such that the at least one wedge is advancing into the engaged state or retracting from the engaged state.

12. The screen assembly of claim 10 wherein the at least one wedge block includes a side skirt, the side skirt extending from the bottom edge in a stepped down configuration.

13. The screen assembly of claim 12 wherein the side skirt engages a second wedge block disposed below and adjacent to the at least one wedge block in a stepped down configuration.

14. The screen assembly of claim 11 wherein the at least one wedge block includes a side skirt and flexible seal, the side skirt extending from the bottom edge in a stepped down configuration and the flexible seal disposed below the bottom edge and proximal to the side skirt.

15. The screen assembly of claim 1 wherein the perimeter portion comprises a frame of rectangularly shaped tube.

16. The screen assembly of claim 1 wherein the perimeter portion of each screen includes a proximal side and a distal side, the proximal side of the perimeter portion being entirely overlapped.

17. The screen assembly of claim 16 wherein the perimeter portion has a lower surface, a seal engaging the lower surface.

18. A screen assembly in a vibrating screen device, the screen assembly comprising a plurality of screens, the vibrating screen device having a basket, the screens disposed within the basket, the plurality of screens constructed and arranged in a stepped down configuration, each screen that is arranged below an adjacent screen in a stepped down configuration is at least partially overlapped by the adjacent screen arranged above, each screen having a middle portion and a perimeter portion, at least one wedge block is used to secure each screen within the vibrating screen device, the middle portion being porous, the perimeter portion being substantially thicker than the middle portion.

19. The screen assembly of claim 18 wherein the perimeter portion comprises a frame of rigid tubing, the perimeter portion having a lower surface having a sealing material engaged thereto.

20. A vibrating screen device comprising a basket having basket portions, the basket portions arranged at different levels so as to accommodate a screen assembly having multiple screens in a stepped down configuration, each screen having a perimeter portion and a middle portion, the middle portion being porous, the perimeter portion being substantially thicker than the middle portion, each screen having a distal side and a proximal side, the proximal side of each screen that is arranged below an adjacent screen in the stepped down configuration is overlapped such that the perimeter portion on the proximal side is overlapped by the adjacent screen arranged above.
